(19) United States
(12) Patent Application Publication
(10) Pub. No.: US 2023/0368658 A1
(43) Pub. Date: Nov. 16, 2023

(54) PROCESSING APPARATUS AND METHOD FOR TRAFFIC MANAGEMENT OF A NETWORK OF ROADS

(71) Applicant: GRABTAXI HOLDINGS PTE. LTD., Singapore (SG)

(72) Inventors: Abhinav SUNDERRAJAN, Singapore (SG); Jagannadan VARADARAJAN, Singapore (SG); Robinson Immanuel KUDALI, Singapore (SG); Xiaocheng HUANG, Singapore (SG)

(21) Appl. No.: 18/028,938

(22) PCT Filed: Oct. 26, 2021
(86) PCT No.: PCT/SG2021/050650

§ 371 Date: Mar. 28, 2023

(30) Foreign Application Priority Data
Nov. 2, 2020 (SG) 10202010875V

(51) Int. Cl. G08G 1/01; G01C 21/00

(52) U.S. Cl. CPC G08G 1/0125; G01C 21/3841; G01C 21/3819

(57) ABSTRACT

A processing apparatus for traffic management of a network of roads is provided, to, generate, based on journey data sets, first count data indicative of a first count of the road users travelling on an incoming road leading to the intersection node, and second count data indicative of a second count of the road users travelling on an outgoing road of at least two outgoing roads, each outgoing road leading away from the intersection node, generate result data indicative of a result that is determined based on the first count and the second count, if the result satisfies a condition for restriction, generate restriction data indicative of a restriction of traffic from the incoming road to the outgoing road via the intersection node, and generate, based on an angular relationship between the outgoing road and the incoming road, type data indicative of a type of the restriction.

### TECHNICAL FIELD

The invention relates generally to the field of at least one of navigation, mapping and communications. One aspect of the invention relates to a processing apparatus for traffic management of a network of roads. Another aspect of the invention relates to a method for traffic management of a network of roads.

One aspect of the invention has particular, but not exclusive, application to navigation (e.g., for vehicles) through a network of roads.

### BACKGROUND

Digital road networks, including OpenStreetMap (OSM), etc., have proliferated over the past few years due to the increasing availability of driver trajectories, satellite images and advances in computer vision. While some digital maps are proprietary, OSM is crowd sourced and free.

Digital road network graphs are associated with several attributes such as direction of travel (DoT), street names, turn restrictions, U-turns, complex traffic intersections, number of lanes, road types, toll roads, traffic lights, etc. It is essential that the aforementioned road attributes are correct to ensure that the given map can be used for routing and navigation. The features should not only be correct but should be periodically maintained and validated to account for the addition of new roads, new traffic rules, temporary/permanent road closures, to ensure seamless and safe navigation capabilities.

### SUMMARY

Aspects of the invention are as set out in the independent claims. Some optional features are defined in the dependent claims.

Implementation of the techniques disclosed herein may provide significant technical advantages. The techniques may enable navigation of traffic through a network of roads. The techniques may enable determination, based on data derived from geolocation transmissions, of a traffic restriction (e.g., a turn restriction) that restricts traffic flow from an incoming road onto an outgoing road (out of at least two outgoing roads) via an intersection node. Whether a traffic restriction is flagged may be determined based on the amount of incoming traffic on the incoming road over a defined time period and the amount of outgoing traffic on the outgoing road over the same defined time period. When it is determined that there is a restriction, the type of the restriction may subsequently be determined based on the geometrical relationship between the incoming road and the outgoing road. The restriction and the type of the restriction may be communicated to road users to aid the road users in navigating through the intersection node.

Therefore, the techniques disclosed herein may enable one or more of (i) improved navigation experience for road users, (ii) better traffic management that may minimise navigation error by road users onto outgoing roads where there may be traffic restrictions, (iii) better traffic management to allow smoother flow of traffic at the intersection node, (iv) alert road users of restrictions and the type of restrictions in advance to aid navigation, thereby potentially minimising traffic disruption at the intersection node, (v) improved safety at the intersection node with users having knowledge of the restrictions and the type of restrictions, (vi) compliance with restrictions that may be imposed at the intersection node, and (vii) savings in terms of travelling time and cost.

The techniques disclosed herein may employ a machine learning model with carefully picked features to achieve high accuracy.

In at least some implementations, the techniques disclosed herein may further determine, where it has been determined that there is a restriction for an outgoing road, whether the outgoing road is a dead-end based on a degree of the last (or end) node associated with the outgoing road.

In at least some implementations, the techniques disclosed herein may determine whether the restriction is applicable to two-wheeled vehicles or four-wheeled vehicles based on data derived using geolocation transmissions associated with two-wheeled vehicles or four-wheeled vehicles respectively.

In at least some implementations, the techniques disclosed herein may process data indicative of the restriction and the type of the restriction to generate one or more of alerts corresponding to the restriction and the type of the restriction.

In at least some implementations, the techniques disclosed herein may process data indicative of a digital map representative of the road network, and the data indicative of the restriction and the type of the restriction for communicating information corresponding to the restriction and the type of the restriction with the digital map.

In an exemplary implementation, the functionality of the techniques disclosed herein may be implemented in software running on a handheld communications device, such as a mobile phone. The software which implements the functionality of the techniques disclosed herein may be contained in an “app”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel for traffic management of a network of roads.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a processing apparatus for traffic management of a network of roads.

FIG. 2B shows a schematic block diagram illustrating a data record.

FIG. 2C shows a schematic block diagram illustrating architecture component of the processing apparatus of FIG. 2A.

FIG. 2D shows a flow chart illustrating a method for traffic management of a network of roads.

FIG. 3 shows an example of a section of a road network graph.

FIG. 4 shows a schematic example of a road network graph.

FIGS. 5 and 6 show flow charts for determining turn restrictions.

FIG. 7 shows a schematic example of a cross intersection.

FIG. 8 shows a schematic example of a road network graph illustrating a turn restriction which is a dead-end.

### DETAILED DESCRIPTION

Various embodiments may include techniques, which may include one or more systems and/or one or more methods, to discover one or more road attributes so as to provide an aid for routing and navigation, for example, from crowd sourced GPS (Global Positioning System) traces.

The techniques disclosed herein may make use of one or more of (i) statistical insights derived from large scale GPS trajectory data that may be in the possession of a service provider for, for example, transport-related services, (ii) map geometry models from internal maps (e.g., maps that may be available internally to or within a service provider) and open source map providers including Open Street Maps (OSM), (iii) application of artificial intelligence (AI)/machine learning (ML) models on GPS traces along with several other road attributes, and (iv) multitude of sensor signals such as speed, bearing, inertial motion sensor based readings, etc.

The techniques may provide for one or more methods to (automatically) discover and/or predict and/or validate one or more road attributes that may be needed for routing and navigation, such as turn restrictions, e.g., if a turn from a road (or road segment) A to road (or segment) B may be possible or restricted. The techniques may further determine whether a given road (or road segment) may be navigable for 2-wheel vehicles and/or 4-wheel vehicles. The techniques may be carried out by leveraging GPS traces obtained, for example, from a plurality (e.g., millions) of transport-related services (e.g., rides) along with artificial intelligence (AI), and machine learning (ML) methods, domain knowledge of the underlying map geometry and associative knowledge from points-of-interest (POIs) (e.g., buildings, landmarks, etc) that are on the road network of interest.

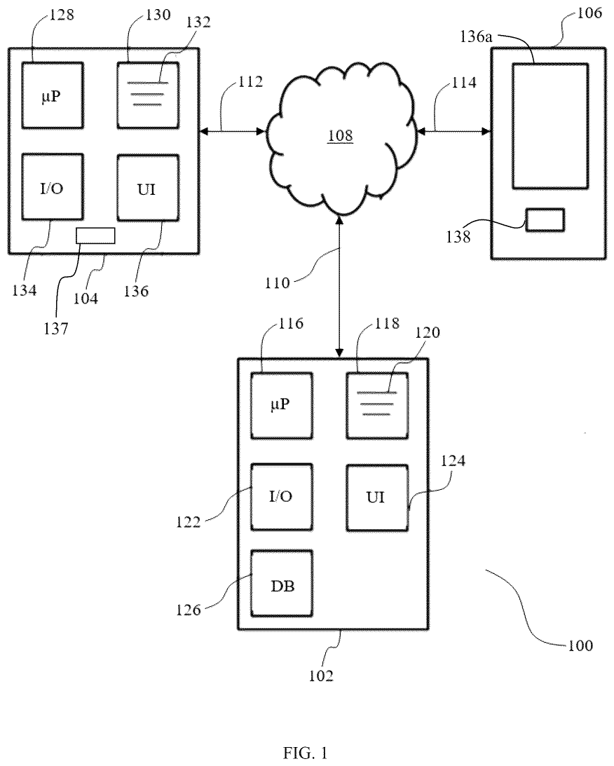

Referring first to FIG. 1, a communications system 100 is illustrated, which may be applicable in various embodiments. The communications system 100 may be for traffic management of a network of roads.

The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (μP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module (which may be or include a transmitter module and/or a receiver module) 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The communications server apparatus 102 may be for traffic management of a network of roads.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module (which may be or include a transmitter module and/or a receiver module) 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like. User communications device 104 may also include satnav components 137, which allow user communications device 104 to conduct a measurement or at least approximate the geolocation of user communications device 104 by receiving, for example, timing signals from global navigation satellite system (GNSS) satellites through GNSS network using communications channels, as is known.

The user communications device 106 may be, for example, a smart phone or tablet device with the same or a similar hardware architecture to that of the user communications device 104. User communications device 106, has, amongst other things, user interface 136a in the form of a touchscreen display and satnav components 138. User communications device 106 may be able to communicate with cellular network base stations through cellular telecommunications network using communications channels. User communications device 106 may be able to approximate its geolocation by receiving timing signals from the cellular network base stations through cellular telecommunications network as is known. Of course, user communications device 104 may also be able to approximate its geolocation by receiving timing signals from the cellular network base stations and user communications device 106 may be able to approximate its geolocation by receiving timing signals from the GNSS satellites, but these arrangements are omitted from FIG. 1 for the sake of simplicity.

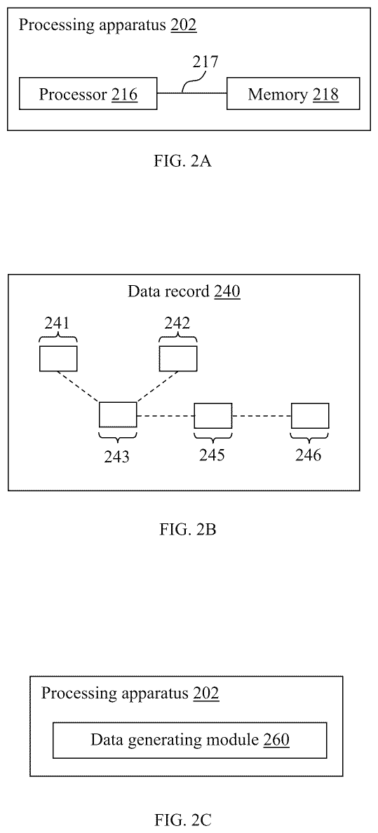

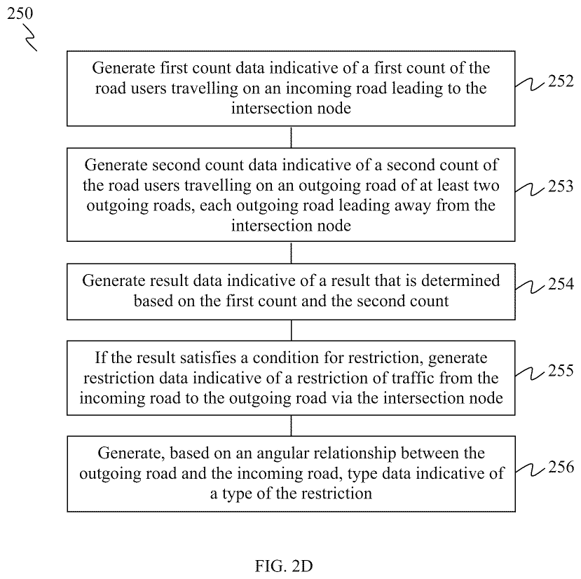

FIG. 2A shows a schematic block diagram illustrating a processing apparatus 202 for traffic management of a network of roads, while FIG. 2B shows a schematic block diagram illustrating a data record 240.

The processing apparatus 202 includes a processor 216 and a memory 218, where the processing apparatus 202 is configured, under control of the processor 216 to execute instructions in the memory 218 to, generate, based on journey data sets, each journey data set including data indicative of a journey by a road user that includes traversing an intersection node of the network of roads and being derived using geolocation transmissions from a communications device of the road user, in one or more data records 240, first count data 241 indicative of a first count of the road users travelling on an incoming road leading to the intersection node, and second count data 242 indicative of a second count of the road users travelling on an outgoing road of at least two outgoing roads, each outgoing road leading away from the intersection node, wherein the incoming road and the at least two outgoing roads intersect at the intersection node, generate, in the one or more data records 240, result data 243 indicative of a result that is determined based on the first count and the second count, if the result satisfies a condition for restriction, generate, in the one or more data records 240, restriction data 245 indicative of a restriction of traffic from the incoming road to the outgoing road via the intersection node, and generate, based on an angular relationship between the outgoing road and the incoming road, in the one or more data records 240, type data 246 indicative of a type of the restriction. The processor 216 and the memory 218 may be coupled to each other (as represented by the line 217), e.g., physically coupled and/or electrically coupled.

In other words, there may be provided a processing apparatus 202 for managing traffic of a network of roads. The processing apparatus 202 may, based on journey data sets where, for each journey data set, the journey data set has data indicative of a journey made or undertaken by a road user that includes traversing (or travelling through or across) an intersection node of the network of roads and being derived using geolocation transmissions from a communications device of the road user (during the journey), generate, in one or more data records 240, first count data 241 indicative of a first count of the road users travelling on an incoming road (as part of the journey) leading to the intersection node, and second count data 242 indicative of a second count of the road users travelling on an outgoing road of at least two outgoing roads (as part of the journey), each outgoing road leading away from the intersection node, where the incoming road and the at least two outgoing roads intersect at the intersection node. Hence, the incoming road and the at least two outgoing roads may be connected to each other at the intersection node. The intersection node, the incoming road and the at least two outgoing roads may, therefore, define an intersection for the network of roads.

As described, the journey undertaken by each road user may involve travelling from the incoming road onto one of the at least two outgoing roads via the intersection node. The incoming road is for incoming traffic leading to the intersection node, while each outgoing road is for outgoing traffic leading away from the intersection node.

In the context of various embodiments, each journey data set may include data related to or corresponding to the journey taken by a road user, which may, for example, be undertaken using a vehicle. The journey may include traversing an intersection node of the network of roads. Each journey data set may include data of at least one of position or location data corresponding to the road user during or along the journey (e.g., in terms of spatial coordinates, such as latitude and longitude), direction of travel, orientation relative to a reference (e.g., north), speed of travel (e.g., vehicle speed), timestamp, ID of the origin of the geolocation transmissions (e.g., communications device ID, vehicle ID, etc.), road ID, node ID, etc.

In the context of various embodiments, a road may have or may be made up of one or more road segments, and at least two nodes. Each road may have a (unique) road ID. A road segment may be defined between two nodes of the road. Each node of the road may be assigned a (unique) node identifier (ID).

In the context of various embodiments, a node may have an associated “degree”, which means a sum of the number of incoming road(s) and the number of outgoing road(s) associated with or connected to the node. Accordingly, with the incoming road and the at least two outgoing roads, the intersection node has a degree of at least three.

In the context of various embodiments, the geolocation transmissions from a communications device may include data of at least one of an identifier (or ID) of the origin of the geolocation transmissions (e.g., communications device ID, vehicle ID, etc.), position or location data corresponding to the road user during or along the journey (e.g., in terms of spatial coordinates, such as latitude and longitude, e.g., associated with roads), direction of travel, orientation relative to a reference (e.g., north), speed of travel (e.g., vehicle speed), timestamp, etc.

In the context of various embodiments, the geolocation transmissions may be provided from the communications device at intervals (during the journey). The geolocation transmissions may include position or location data corresponding to the road user during or along the journey. The geolocation transmissions may include data derived from a global navigation satellite system (GNSS), e.g., global positioning system (GPS). The geolocation transmissions, for example, may be or may include (raw) GPS data or GPS pings.

The geolocation transmissions from the communications device of a road user may be distinct from the geolocation transmissions from the communications device of another road user, for example, identifiable based on the ID of the communications device. Hence, based on such distinct geolocation transmissions, the count or number of road users travelling on the incoming road and one or more of the at least two outgoing roads may be determined or computed.

The geolocation transmissions from the communications devices of road users may be transmissions that occurred over a defined time period, for example, one month.

In the context of various embodiments, the geolocation transmissions may be provided via any suitable communications networks, for example, via wifi, (mobile) cellular communications network, etc.

In the context of various embodiments, the geolocation transmissions may be (transmitted) to the processing apparatus 202.

In the context of various embodiments, the geolocation transmissions may be (transmitted) from a communications device that includes, but not limited to, a smart phone, tablet, handheld/portable communications device, location tracking device, navigation device (including an in-vehicle navigation device), etc.

In the context of various embodiments, the geolocation transmissions may be generated from apps (e.g., ride-hailing apps) resident on road users' mobile phones. The geolocation transmissions may be transmitted (e.g., periodically) by the users' mobile phone apps as the users undertake the corresponding journeys, for example, to the processing apparatus 202 or a server.

The first count of the road users is preferably equal to or more than a defined threshold, for example, 200, for determining the result. This is so that there may be sufficient traffic coverage at the intersection node for computing the result.

In the context of various embodiments, the processing apparatus 202 may process data corresponding to the network of roads to identify the incoming road and the at least two outgoing roads intersecting at the intersection node.

The data corresponding to the network of roads may be stored in the processing apparatus 202, e.g., in the memory 218, or the data corresponding to the network of roads may be stored in another location (e.g., in a server) and may be received by or accessible to the processing apparatus 202.

In the context of various embodiments, the data corresponding to the network of roads may include, but not limited to, data or information on at least one of a plurality of roads within the network, one or more road segments of each road, one or more nodes of each road, relationship between the roads (e.g., including any connection therebetween), geometrical layout of the network, direction of traffic on respective roads (e.g., including whether the roads may be roads for one way traffic or bi-directional traffic), intersection nodes, traffic light arrangements, road classification (e.g., whether the roads are major or minor roads, residential roads, highways, etc.), dimensions of the roads (e.g., lengths, widths), names of the roads, data or information (e.g., names, addresses, etc.) on one or more points-of-interest (POIs) within the network, etc.

The processing apparatus 202 may further generate, in the one or more data records 240, result data 243 indicative of a result that may be determined based on the first count and the second count. If the result satisfies a condition for restriction, the processing apparatus 202 may generate, in the one or more data records 240, restriction data 245 indicative of a (traffic) restriction (or prohibition or prevention) of traffic from the incoming road to the outgoing road via the intersection node (e.g., no turning or onward travel from the incoming road onto the outgoing road via the intersection node). The processing apparatus 202 may further generate, based on an angular relationship between the outgoing road and the incoming road, in the one or more data records 240, type data 246 indicative of a type of the restriction.

In the context of various embodiments, the processing apparatus 202 may determine the angular relationship between the outgoing road and the incoming road based on data indicative of a geometrical layout of the network. The data indicative of the geometrical layout of the network of roads may include, but not limited to, data or information on one or more of geometrical arrangement of the roads, geometrical relationship (e.g., including angular relationship) between the roads, shapes of the roads (e.g., whether the roads are straight roads, curved roads, etc.), curvatures of the roads, etc. The data indicative of the geometrical layout of the network may be part of the data corresponding to the network of roads

The restriction may be communicated to (road) users (e.g., via (communications) devices of the users), for example, when their own journeys involve the intersection node. A user may be alerted to the restriction and the type of the restriction by means of visual information or alert, including but not limited to, textual information, graphical information, or audio information or alert, etc. As non-limiting examples, the restriction and the type of the restriction may be presented in at least one of visual form (e.g., via use of colour schemes, patterns, symbols or characters, e.g., placing of a “x” at a suitable location) on a digital map, textual form (e.g., “No turning into Road Y from Road X at Intersection Z”) on the digital map or via a (communications) device, or audio form via a (communications) device, to alert the road user of no traffic flow from the incoming road to the outgoing road via the intersection node.

The (communications) device through which such information or alert associated with restriction may be provided may include, but not limited to, a smart phone, tablet, handheld/portable communications device, desktop or laptop computer, terminal computer, navigation device (including an in-vehicle navigation device), etc.

In the context of various embodiments, the one or more data records 240 may include one or more count data fields, one or more result data fields, one or more restriction data fields, and one or more type data fields. The processing apparatus 202 may generate, for or in the one or more count data fields, the first count data 241 and the second count data 242. The processing apparatus 202 may generate, for or in the one or more result data fields, the results data 243. The processing apparatus 202 may generate, for or in the one or more restriction data fields, the restriction data 245. The processing apparatus 202 may generate, for or in the one or more type data fields, the type data 246.

In the context of various embodiments, the one or more data records 240 may be associated with or accessible by the processing apparatus 202. The one or more data records 240 may be generated by the processing apparatus 202. The one or more data records 240 may be modified or updated by the processing apparatus 202. The one or more data records 240 may be stored at the processing apparatus 202, e.g., in the memory 218.

In various embodiments, for generating the result data 243, the processing apparatus 202 may generate the result data 243 indicative of the result that may be determined based on a ratio defined by the second count to the first count, and wherein the result satisfies the condition for restriction if the result is less than a defined threshold. The result may be the ratio itself or a percentage that is determined based on the ratio. The result may satisfy the condition for restriction if the ratio is less than a defined threshold or the percentage is less than a defined threshold. As a non-limiting example, the condition for restriction may include a condition where the second count is less than 1% of the first count.

In various embodiments, for generating the restriction data 245, the processing apparatus 202 may generate the restriction data 245 if the result satisfies the condition for restriction, and if the second count is less than another defined threshold.

Starting from the incoming road to the outgoing road in an anti-clockwise direction, if the angular relationship between the outgoing road and the incoming road includes an angle in a first range of between about 80° and about 100° (e.g., 80°≤θ≤100°, the processing apparatus 202 may, for generating the type data 246, generate the type data 246 indicative of a no-right turn restriction, and, if the angular relationship between the outgoing road and the incoming road includes an angle in a second range of between about 255° and about 285° (e.g., 255°≤θ≤285°, the processing apparatus 202 may, for generating the type data 246, generate the type data 246 indicative of a no-left turn restriction.

Starting from the incoming road to the outgoing road in an anti-clockwise direction, if the angular relationship between the outgoing road and the incoming road includes an angle outside of the first range and the second range, the processing apparatus 202 may, for generating the type data 246, generate the type data 246 indicative of a no-entry restriction.

The processing apparatus 202 may further generate, if a degree of an end node (or last node) associated with the outgoing road is determined to be one, in the one or more data records 240, data indicative of the outgoing road being a dead-end road. As the end node has a degree of one, apart from the outgoing road, there is no other road associated with or connected to the end node to allow traffic flow through the end node. In other words, the outgoing road is a no-through road, with no traffic flow through the end node. The dead-end restriction may be communicated to (road) users (e.g., via (communications) devices of the users). A user may be alerted to the dead-end restriction by means of visual information or alert, including but not limited to, textual information, graphical information, etc., or audio information or alert.

In various embodiments, the geolocation transmissions may include or consist of geolocation transmissions associated with the road user undertaking the journey using a two-wheeled vehicle. In this way, the restriction may be a restriction for two-wheeled vehicles. A two-wheeled vehicle means a vehicle that runs on two wheels, e.g., a bicycle, a motorcycle, etc.

In various embodiments, the geolocation transmissions may include or consist of geolocation transmissions associated with the road user undertaking the journey using a four-wheeled vehicle. In this way, the restriction may be a restriction for four-wheeled vehicles. A four-wheeled vehicle means a vehicle that runs on four wheels, e.g., a car, a van, etc.

It should be appreciated that the geolocation transmissions may include or consist of geolocation transmissions associated with the road user undertaking the journey using any other types of vehicles, including a vehicle that runs on more than four wheels, e.g., a container truck.

The processing apparatus 202 may further add (include or incorporate) the restriction data 245 and the type data 246 to data corresponding to the network of roads.

The processing apparatus 202 may further, in response to a request from a user (or requester) to access data associated with the intersection node, communicate the restriction data 245 and the type data 246 to a (communications) device of the user for communicating the restriction and the type of the restriction to the user.

The processing apparatus 202 may further process the restriction data 245 and the type data 246 to generate at least one of visual information or audio information (corresponding to or associated with the restriction) for communicating the restriction and the type of the restriction to users.

The processing apparatus 202 may further process data indicative of a digital map representative of the network of roads, the restriction data 245 and the type data 246 for communicating information corresponding to the restriction and the type of the restriction with the digital map (e.g., displaying the digital map with information corresponding to the restriction and the type of the restriction). The data indicative of the digital map may be stored in the processing apparatus 202, e.g., in the memory 218, or the data indicative of the digital map may be stored in another location and may be received by or accessible to the processing apparatus 202. The information corresponding to the restriction and the type of the restriction may be in the form of visual information or audio information.

FIG. 2C shows a schematic block diagram illustrating architecture component of the processing apparatus 202. That is, the processing apparatus 202 may further include a data generating module 260 to generate the respective data 241, 242, 243, 245, 246 (see FIG. 2B).

In the context of various embodiments, the processing apparatus 202 may be or may include a communications server apparatus, and may, for example, be as described in the context of the server device 102 (FIG. 1). The processor 216 may be as described in the context of the processor 116 (FIG. 1) and/or the memory 218 may be as described in the context of the memory 118 (FIG. 1).

In the context of various embodiments, the processing apparatus 202 may be a single server, or have the functionality performed by the processing apparatus 202 distributed across multiple apparatus components.

In the context of various embodiments, the processing apparatus 202 may be or may include a (communications) device of a (road) user.

FIG. 2D shows a flow chart 250 illustrating a method for traffic management of a network of roads.

Based on journey data sets, each journey data set having data indicative of a journey by a road user that includes traversing an intersection node of the network of roads and being derived using geolocation transmissions from a communications device of the road user, at 252, first count data indicative of a first count of the road users travelling on an incoming road leading to the intersection node is generated in one or more data records, and, at 253, second count data indicative of a second count of the road users travelling on an outgoing road of at least two outgoing roads is generated in the one or more data records, each outgoing road leading away from the intersection node. The incoming road and the at least two outgoing roads intersect at the intersection node.

At 254, result data indicative of a result that is determined based on the first count and the second count is generated in the one or more data records.

At 255, if the result satisfies a condition for restriction, restriction data indicative of a restriction of traffic from the incoming road to the outgoing road via the intersection node is generated in the one or more data records.

At 256, based on an angular relationship between the outgoing road and the incoming road, type data indicative of a type of the restriction is generated in the one or more data records.

At 254, the method may include generating the result data indicative of the result that may be determined based on a ratio defined by the second count to the first count, and the result satisfies the condition for restriction if the result is less than a defined threshold.

At 255, the method may include generating the restriction data if the result satisfies the condition for restriction, and if the second count is less than another defined threshold.

Starting from the incoming road to the outgoing road in an anti-clockwise direction, if the angular relationship between the outgoing road and the incoming road includes an angle in a first range of between about 80° and about 100°, at 256, the type data indicative of a no-right turn restriction is generated, and, if the angular relationship between the outgoing road and the incoming road includes an angle in a second range of between about 255° and about 285°, the type data indicative of a no-left turn restriction is generated.

Starting from the incoming road to the outgoing road in an anti-clockwise direction, if the angular relationship between the outgoing road and the incoming road includes an angle outside of the first range and the second range, at 256, the type data indicative of a no-entry restriction is generated.

The method may further include generating, if a degree of an end node associated with the outgoing road is determined to be one, in the one or more data records, data indicative of the outgoing road being a dead-end road.

In various embodiments of the method, the geolocation transmissions may include or consist of geolocation transmissions associated with the road user undertaking the journey using a two-wheeled vehicle.

In various embodiments of the method, the geolocation transmissions may include or consist of geolocation transmissions associated with the road user undertaking the journey using a four-wheeled vehicle.

The method may further include adding the restriction data and the type data to data corresponding to the network of roads.

The method may further include, in response to a request from a user (or requester) to access data associated with the intersection node, communicating the restriction data and the type data to a device of the user for communicating the restriction and the type of the restriction to the user.

The method may further include processing the restriction data and the type data to generate at least one of visual information or audio information for communicating the restriction and the type of the restriction to users.

The method may further include processing data indicative of a digital map representative of the network of roads, the restriction data and the type data for communicating information corresponding to the restriction and the type of the restriction with the digital map (e.g., displaying the digital map with information corresponding to the restriction and the type of the restriction).

The method as described in the context of the flow chart 250 may be performed in a processing apparatus (e.g., 202; FIG. 2A) for traffic management of a network of roads, under control of a processor of the apparatus.

It should be appreciated that descriptions in the context of the processing apparatus 202 may correspondingly be applicable in relation to the method as described in the context of the flow chart 250, and vice versa.

There may also be provided a computer program product having instructions for implementing the method for traffic management of a network of roads as described herein.

There may also be provided a computer program having instructions for implementing the method for traffic management of a network of roads as described herein.

There may further be provided a non-transitory storage medium storing instructions, which, when executed by a processor, cause the processor to perform the method for traffic management of a network of roads as described herein.

Various embodiments disclosed herein may determine whether there is any restriction to traffic from an incoming road turning into an outgoing road via a node between the two roads.

The techniques may obtain raw GPS data (GPS ping) from vehicles by extracting driver trajectories (a driver trajectory is a timestamp order sequence of GPS pings for a particular vehicle for a trip from the vehicle's origin to destination) for all vehicles over all trips for a city over a defined time period (e.g., one month period). The techniques may process the data to derive snapped driver trajectories (which is a timestamp order sequence of snapped GPS pings (or processed GPS data) for a particular vehicle for a trip from the vehicle's origin to destination to localise the positions of the vehicles onto roads on a digital road network. The processed GPS data (snapped GPS ping) may include data corresponding to nodes on the road. It should be appreciated that GPS data is a non-limiting example, and that any suitable global navigation satellite system (GNSS) data may be used in the techniques disclosed herein.

For an incoming road having at least a certain number of snapped GPS pings (e.g., ≥200) over the defined time period, turn ratios may be determined for turns into the outgoing roads from the incoming roads. For example, if there are 1000 snapped GPS pings for an incoming road and 200 snapped GPS pings for an outgoing road that is connected to the incoming road over the defined time period, the corresponding turn ratio is 0.2.

If a turn ratio is less than a threshold value, a turn restriction may be flagged for the outgoing road. In other words, a flag may be raised that turning from the incoming road to the corresponding outgoing road may be restricted or prohibited. For flagging the turn restriction, it may be possible to apply a second condition that the number of snapped GPS pings for the outgoing road is below a defined threshold value.

Subsequently, for outgoing roads that have been flagged for turn restrictions, the angle, θ, of the outgoing road relative to the incoming road may be determined, and based on the determined angle, θ, the turn restriction may be categorised as “no right turn” if 80°≤θ≤100°, “no left turn” if 255°≤θ≤285°, or otherwise as “no entry”.

The techniques may further determine whether there may be turn restrictions for 2-wheel vehicles and/or 4-wheel vehicles, by following the above-mentioned methodology, but specifically using snapped driver trajectories associated with 2-wheel vehicles or 4-wheel vehicles.

Further, the techniques may mark the turn restriction as a “dead-end” where there are no outgoing roads from the corresponding node. This, for example, may happen if the node for the flagged outgoing road has a degree of one, where there is an incoming road to the node, without any outgoing roads from the node. The node, therefore, is a last/end node.

Various embodiments or techniques will now be further described in detail.

Generally, a road network may be represented as a directed graph G(V, E), where V refers to a set of nodes and E refers to a set of directed edges connecting the nodes. Two nodes may be linked by an “edge”, referring to a road segment or a road, depending on the context. Multiple road segments may make up a road. A node may be associated with one or more incoming edges leading to the node, and/or one or more outgoing edges leading away from the node. The network graph structure may enable identification of the roads connected to each node, including incoming road(s) to the node and outgoing road(s) from the node, and the number thereof.

A road on a road network graph may have 2 or more nodes. If a road has “n” nodes, the road may have “n−1” edges or segments. Each road has a road ID, and each node has a node ID. Each segment is generally a straight line segment. The curvature of a road, thus, may be given by multiple line segments (or road segments).

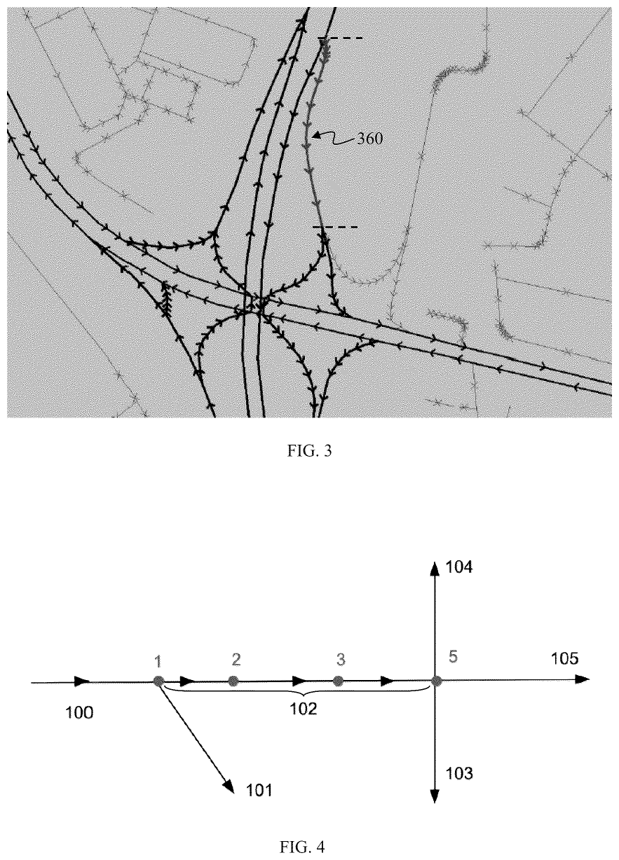

FIG. 3 shows an example of a section of a road network graph. Using the road 360, with its boundaries indicated with the two dashed lines, as a non-limiting example, the road 360 may have an identifier or ID (i.e., road ID), e.g., 22718052. While not clearly shown in FIG. 3, road 360 has 11 road segments and 12 nodes. In FIG. 3, nodes are represented by the arrow heads while road segments are defined by the lines between respective two adjacent nodes. Each node may have its own identifier or ID (i.e., node ID), e.g., 133745557, 6076301329, 6076301328, etc.

Referring to FIG. 3, roads with cross marks (“x”) represent bi-directional roads with two-way traffic, while roads with arrows (e.g., road 360) represent one-way roads.

Further, the graph structure, similar to that shown in FIG. 3, may allow identification of the number of incoming and outgoing edges, i.e., roads at every node in the road network graph.

The techniques disclosed herein may make use of GPS data. A GPS ping (raw GPS data) of a vehicle may be defined by a tuple given by (vehicle_id, latitude, longitude, vehicle_bearing, speed, timestamp, accuracy). The various parameters may be defined as follows:
vehicle_id is a unique ID for each and every vehicle;
latitude and longitude represent the location of the vehicle at a given timestamp;
bearing indicates the orientation of the vehicle to true north;
accuracy is defined as the radius of 68% confidence. If a circle is drawn centered at the latitude and longitude, and with a radius equal to the accuracy, then, there is a 68% probability that the true location is inside the circle.

Using an algorithmic procedure called “map-matching” (also referred to as “snap-to-road”), the position of the vehicle may be localised onto a digital road network, i.e., the road (e.g., in terms of the road ID) the vehicle is driven on. Map-matching may remove GPS noise to infer the exact position (relatively) of the vehicle on the road network.

Thus a map-matched or snapped GPS ping (or processed GPS data) may be a tuple of the form (vehicle_id, speed, timestamp, road_id, start_node, end_node, accuracy). The parameters start_node and end_node indicate two successive nodes, i.e., in the node ID sequence constituting the road. This may mean that a valid start_node, end_node pair may represent two adjacent nodes, with a road segment defined therebetween.

The techniques disclosed herein may also make use of a vehicle's trajectory, which represents a timestamp order sequence of pings or snapped driver pings for a particular vehicle ID for a trip from the vehicle's origin to destination.

Techniques disclosed herein may provide for rule-based modelling of traffic. Based on the degree of nodes in the road network graph and the angles between the edges incident on a node, a methodology is provided to identify nodes, and, further, identify turn restrictions at the nodes. Such information can be leveraged by travel time estimation models as well as being relevant (and potentially crucial) for navigation purposes.

Compared to known approaches, the techniques disclosed herein may also leverage upon the angle between incoming and outgoing edges to recommend one or more of no-left, no-right and no-entry suggestions, which is relevant or necessary for navigation.

For identification of turn restrictions, the techniques disclosed herein may leverage upon the datastore (or database) of driver trajectories, which, for example, may be in the possession of a service provider for, for example, transport-related services.

As a non-limiting example, a turn restriction may be defined based on Open Street Maps (OSM) conventions such as
way “from_way” (or road “from_road”) which has the function/role “from”;
way “to_way” (or road “to_road”) which has the function/role “to”;
node “node_id” which has the function/role “via”.

Based on the above, a turn restriction which restricts or prevents flow of traffic may be indicated from road from_road to road to_road via node node_id. The reasons for turn restrictions may include traffic regulations or due to the road being non navigable for 4-wheel vehicles given the width or non paved nature of the road (in suburban areas of a city, for example), etc. Separate turn restrictions for 2-wheel vehicles and 4-wheel vehicles may be provided, to factor in the aforementioned consideration of road width and/or paved nature.

FIG. 4 shows a schematic example of a road network graph. There are shown 6 roads (represented by arrow lines with the direction of the arrows indicating the direction of travel) having respective road IDs 100, 101, 102, 103, 104, 105, 106, and four nodes (represented by solid circles) having respective node IDs 1, 2, 3, 5.

A node may have a defined “degree” representing the sum of incoming and outgoing edges/roads (or road segments) at the node. For example, the degree of node 1 is three with one incoming edge (from_road) 100 and two outgoing edges (to_road) 101 and 102. As a further example, the degree of node 5 is four with one incoming edge 102 and three outgoing edges 103, 104 and 105. Nodes 2 and 3 have degrees of two, respectively associated with one incoming edge and one outgoing edge.

For the nodes mentioned, turn ratios (a “turn ratio” may be determined from the number of vehicles travelling on an outgoing road associated with a node to the number of vehicles travelling on an incoming road associated with the node) may be determined (or computed) for valid intersections, and, following from that, turn restrictions, if any, may be identified. Nodes may be identified as valid intersections for the purpose of computing turn ratios and identifying turn restrictions, based on the degree of the nodes.

Generally, for nodes having a degree of 2, such as nodes 2 and 3 of FIG. 4, no determination of turn ratios for these nodes is necessary as traffic or vehicle flow will continue unabated as there is no other exit or entry. As node 1 has two outgoing edges 101 and 102, node 1 may be identified as a valid intersection for determining turn ratios. Similarly, node 5 is a valid intersection as there are three outgoing edges 103, 104 and 105. Therefore, to have any meaningful turn ratios, and consequently, identification of turn restrictions, techniques disclosed herein may identify a node as a valid intersection for processing, if the degree of the node is at least 3.

Using node 1 as a non-limiting example, where the from_road is road 100 and the to_roads are roads 101 and 102, and assuming that a turn restriction exists on to-road 101 from from_road 100, the turn restriction may be defined with a tuple in the form of (from_road, via_node, to_road), e.g., (100, 1, 101) which indicates that there is turn restriction from from_road 100 to to_road 101 via the via_node 1.

As described, a snapped driver trajectory may include a time ordered sequence of road-IDs a vehicle has traversed from its origin to the destination. Referring to FIG. 4, a valid transition may be from road with ID 100 to roads with ID 101 or 102, while an invalid transition may be from edge 104 to edge 100, which may occasionally occur due to GPS errors which the “snap-to-road” algorithm may fail to pick up. Thus, a valid sequence may, for example, be [100→102→105], while the sequence [100→102→105→103] contains an invalid transition [105→103] where such invalid subsequence is not considered when computing turn restrictions.

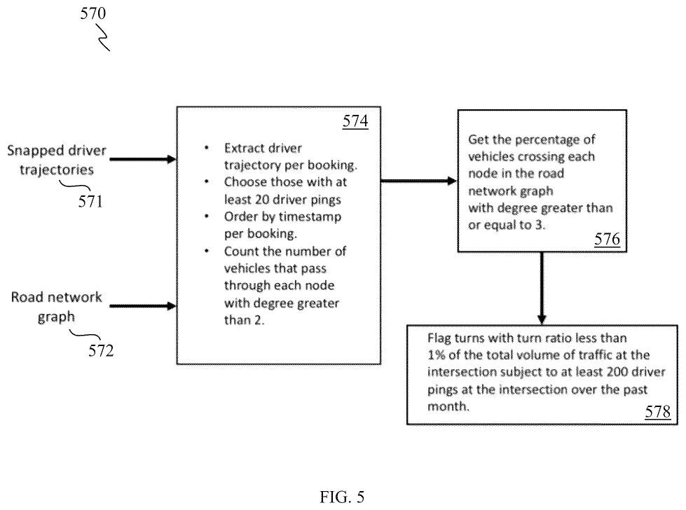

FIG. 5 shows, as a non-limiting example, a flow chart 570 for determining turn restrictions. The flow chart 570 illustrates the methodology for extracting turn ratios and flagging possible turn restriction from driver trajectories, based on snapped driver trajectories 571 and road network graph 572. At 574, for a journey (e.g., corresponding to a booking for transport-related service) with at least 20 driver GPS pings, the driver trajectory may be extracted. For each such journey, the associated pings may be ordered sequentially in terms of the timestamps per journey. For each of the nodes (intersections) having a degree that is greater than 2, the number of vehicles passing through the node may be determined or computed.

At 576, for each of the nodes (intersections) having a degree of 3 or more, the percentage of vehicles crossing the node may be determined or computed.

At 578, for nodes or intersections where there may be at least 200 driver GPS pings during a defined past period (e.g., past one month), turns (e.g., into outgoing roads leading away from the nodes) with a turn ratio that is, for example, less than 1% of the total volume of traffic at the nodes may be flagged with turn restrictions.

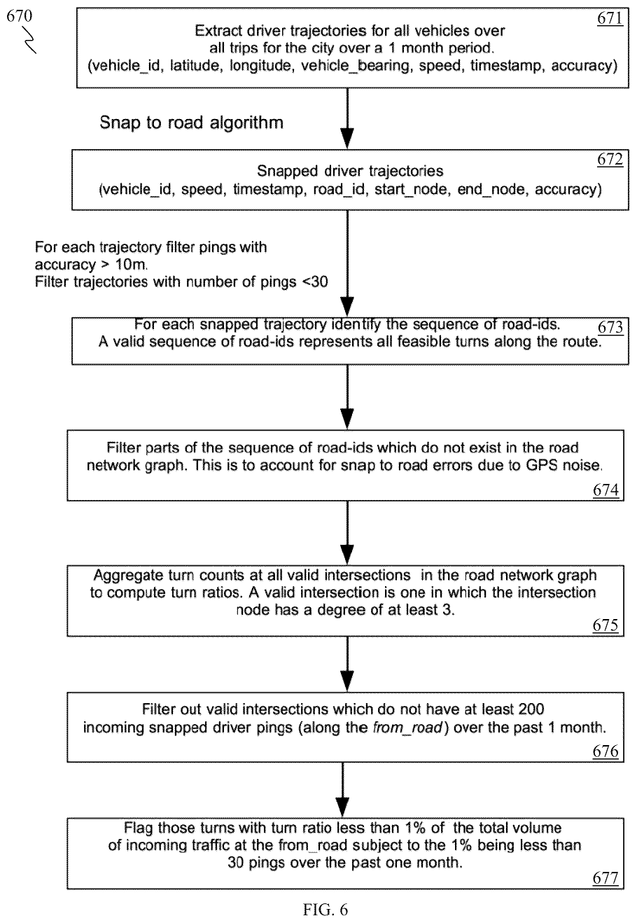

FIG. 6 shows, as a non-limiting example, a flow chart 670 for determining turn restrictions.

At 671, the driver trajectories for all vehicles over all trips for a defined city over a defined time period (e.g., one month) may be extracted or obtained. Each driver trajectory may include a series of GPS pings, where each ping may be defined by a tuple given by (vehicle_id, latitude, longitude, vehicle_bearing, speed, timestamp, accuracy).

At 672, a “snap-to-road” algorithm may be used to generate or derive snapped driver trajectories. Each snapped driver trajectory may include a series of snapped GPS pings, where each snapped GPS ping may be defined by a tuple given by (vehicle_id, speed, timestamp, road_id, start_node, end_node, accuracy). Effectively, the algorithm may map or localise the position of the vehicle onto a (digital) road network, where roads may be identified in terms of their corresponding road IDs.

At 673, the snapped driver trajectories may be filtered. For each trajectory, pings with an accuracy that is, for example, more than 10 meters, may be filtered and removed. Trajectories with less than 30 pings may be filtered and removed. Subsequently, for each snapped trajectory, the sequence of road IDs may be identified. A valid sequence of road IDs represents (all) feasible turns along the route.

At 674, one or more parts of the sequence of road IDs which do not exist in the road network graph may be filtered and removed, so as to account for snap-to-road errors that may occur due to GPS noise.

At 675, turn counts at (all) valid intersections in the road network graph may be aggregated to compute turn ratios. A valid intersection is one in which the intersection node has a degree of at least 3.

At 676, valid intersections having less than a defined number or threshold (e.g., <200) of incoming snapped driver pings (along the from_road) over a defined period (e.g., past one month) may be filtered and removed. It should be appreciated that any suitable threshold may be defined or set.

At 677, turns with a turn ratio of less than a defined percentage (e.g., 1%) of the total volume of incoming traffic at the from_road may be flagged, subject to the percentage being equivalent to less than, for example, 30 pings, over the defined period, e.g., past one month. It should be appreciated that any suitable threshold may be defined or set for the percentage and/or the number of pings.

As described, rules for flagging a turn restriction at an intersection may be provided. Turn restrictions may be computed by aggregating the number of incoming and outgoing snapped driver pings of all valid driver trajectory sequences.

As a non-limiting example, with reference to FIG. 4, assume 1000 GPS pings were recorded on the from_road 100 while 800 driver pings were recorded on road_id 102 and the rest (i.e., 200 pings) on road_id 101 via node 1. The turn ratios are, therefore, 0.8 and 0.2 respectively at the intersection node 1 on to_road 102 and to_road 101 respectively.

For flagging a turn restriction, in order to ensure that the results are statistically significant, a condition may be defined to require at least 200 GPS pings recorded over a from_road of a valid intersection over a 1-month period. A to_road at the turn may be flagged as a turn restriction if the turn ratio is less than 1% and the number of snapped driver pings on the to_road is less than 30. These thresholds were determined based on empirical results on precision and recall on being able to identify turn restrictions (from street view).

The techniques disclosed herein may further define the turn restrictions as a no-left turn, or a no-right turn, or a no-entry. The angle between the from_way (incoming road) and to_way (outgoing road) at node_id may be used as the basis for recommendation of no-left turn/no-right turn, etc. The following non-limiting rule may be used for the recommendations.

```
if angle >= 80 and angle <= 100:
  recommendation=”no-right-turn”
else if angle >= 255 and angle <= 285:
  recommendation = ″no-left-turn″
else
  recommendation=”no-entry”
```

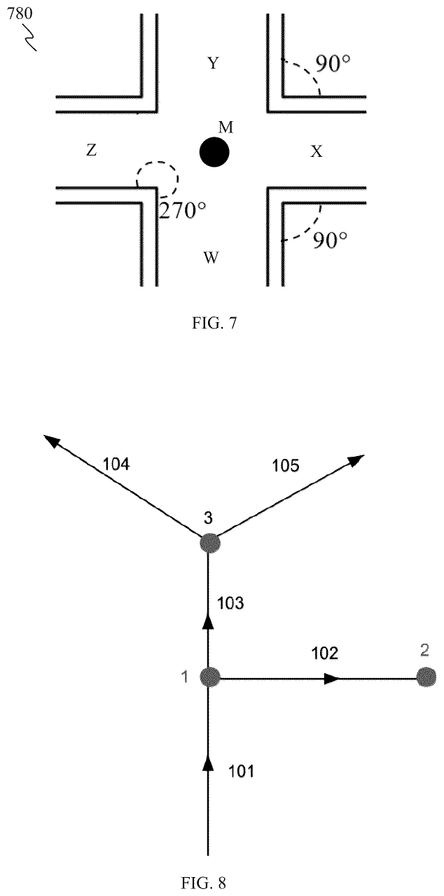

FIG. 7 shows a schematic example of a cross intersection 780 to illustrate determination of the type of turn restrictions based on angle between roads. A solid circle is shown in FIG. 7 to indicate a (intersection) node M, where four roads, namely, road W, road X, road Y and road Z, intersect.

The type of turn restriction may be determined by calculating the angle between the from_road and to_road at the via_node. Referring to FIG. 7 and assuming the conditions/requirements as described herein for turn ratios and for flagging turn restrictions are satisfied, from_road W to to_road Z is flagged as no-left turn as the angle between roads W and Z at the intersecting via_node M is 270°, while from_road W to to_road Y is flagged as no-entry as the angle between roads W and Y at the intersecting via_node M is 180°. Similarly, as the angle between from_road X and to_road Y at the intersecting via_node M is 90°, a no-right turn is flagged.

The techniques disclosed herein may determine whether a turn restriction may lead to a dead-end. FIG. 8 shows a schematic example of a road network graph illustrating a turn restriction which is a dead-end. There are shown five roads (represented by arrow lines with the direction of the arrows indicating the direction of travel) having respective road IDs 101, 102, 103, 104, 105, and three nodes (represented by solid circles) having respective node IDs 1, 2, 3. As a non-limiting example, assume that there is a flagged turn restriction from the from_road 101 to the to_road 102 via the via_node 1. The turn restriction tuple may be in the form of (101, 1, 102). As the degree of the last node of road_id 102, i.e., node 2, is one, meaning that there are no outgoing roads or edges from the node 2, the turn restriction or its tuple may be marked as a dead-end.

TABLE 1 shows an example table providing information and recommendations for turn restrictions which have been identified or flagged. The data format basically identifies restrictions on vehicle flow from from_way (identified by the incoming road ID) to to_way (identified by the outgoing road ID) via the node_id at which both the ways intersect. The road type for the from_way roads and the to_way roads, e.g., residential, are identified in TABLE 1 under “way_type_from” and “way_type_to”. Classification of road types may, for example, follow the OpenStreetMap definition of road types (https://wiki.openstreetmap.org/wiki/Key:highway#Values). The angle between the from_way road and the to_way road at the intersecting node_id is also shown in TABLE 1.

TABLE 1

| from_way | to_way | way_type_from | way_type_to | recommendation |
|---|---|---|---|---|
| 94093939 | 569729286 | secondary | residential | no-left-turn |
| 121963310 | 360266208 | residential | residential | no-left-turn |
| 141951307 | 141951308 | residential | residential | no-left-turn |
| 142575988 | 142576013 | residential | residential | no-left-turn |
| 165617588 | 534826254 | residential | residential | no-right-turn |
| 166671762 | 555344591 | residential | service | no-right-turn |
| 166671762 | 593551762 | residential | residential | no-right-turn |

| is_dead_end | node_id | angle | num_turns | sum_turns | percentage |
|---|---|---|---|---|---|
| FALSE | 1093860242 | 271.5 | 0 | 582 | 0 |
| FALSE | 5391446925 | 264.8 | 0 | 332 | 0 |
| FALSE | 1553827070 | 258.3 | 0 | 1603 | 0 |
| FALSE | 1560235528 | 264.0 | 0 | 1410 | 0 |
| FALSE | 5185825741 | 89.23 | 4 | 492 | 0.81 |
| TRUE | 5358196826 | 82.79 | 4 | 1157 | 0.34 |
| FALSE | 5682308810 | 85.5 | 4 | 1157 | 0.34 |

The column of sum_turns in TABLE 1 represents the total number of snapped driver pings (or distinct vehicle pings) on the from_way road at the intersection represented by the node_id. The column of num_turns in TABLE 1 represents the number of (distinct) vehicle pings recorded on the adjacent to_way road with turn restrictions (which would be very minimal), i.e., the number of pings that traversed from the from_way road to the to_way road. The number of pings computed for both sum_turns and num_turns are pings aggregated over 1 month.

The “percentage” column in TABLE 1 shows the percentage of vehicles that traversed from the from_way road to the to_way road, and may be defined as (num_turns*100/sum_turns). The “percentage”, thus, represents the turn ratio.

Based on the “angle” information and the rule described above, recommendations of no-left turn or no-right turn may be made, as shown in TABLE 1. Further, turns are identified as whether leading to a dead-end or not, i.e., whether to_way road is a dead-end or not, as shown in TABLE 1. For example, the turn restriction with tuple (166671762, 5358196826, 555344591) is identified as a dead-end.

The techniques disclosed herein may determine 2-wheel and 4-wheel turn restrictions using the same methodology described above. For computing turn restrictions for 2-wheel vehicles, snapped driver trajectories from 2-wheel vehicles only, e.g., motorbikes, may be aggregated and used for determination of turn restrictions. Similarly, turn restrictions for 4-wheel vehicles may be determined by aggregating snapped driver trajectories of different four-wheel vehicles only, e.g., cars, vans, etc. The trajectories may, for example, be derived from vehicles used for transport-related services, e.g., ride-hailing services, etc.

As a non-limiting example, 1 month's worth of GPS trajectories from vehicles in a city (2-wheel vehicles and/or 4-wheel vehicles) may be used to determine turn restrictions. Before identifying a turn restriction, a requirement may be set for a minimum of 200 distinct vehicle pings at the incoming road of an intersection, i.e., at the from_way road, to ensure sufficient traffic coverage. A turn restriction at node_id may be flagged if the percentage of vehicle transiting to the to_way road from the from_way road is less than 1% of sum_turns at the from_way road. Further, turn restrictions may be identified separately for 2-wheel vehicles and 4-wheel vehicles.

Based on the cutoffs or conditions mentioned above, the techniques disclosed herein have been used to identify about 14.2 k turn restrictions for 4-wheel vehicles and about 10.2 k for 2-wheel vehicles in Jakarta for the month of February 2019. Based on extensive validation via manual verification, an accuracy exceeding 98% has been achieved with the techniques.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A processing apparatus for traffic management of a network of roads, comprising a processor and a memory, the processing apparatus being configured, under control of the processor to execute instructions in the memory to:
generate, based on journey data sets, each journey data set comprising data indicative of a journey by a road user that comprises traversing an intersection node of the network of roads and being derived using geolocation transmissions from a communications device of the road user, in one or more data records,
first count data indicative of a first count of the road users travelling on an incoming road leading to the intersection node, and
second count data indicative of a second count of the road users travelling on an outgoing road of at least two outgoing roads, each outgoing road leading away from the intersection node,
wherein the incoming road and the at least two outgoing roads intersect at the intersection node;
generate, in the one or more data records, result data indicative of a result that is determined based on the first count and the second count;
if the result satisfies a condition for restriction, generate, in the one or more data records, restriction data indicative of a restriction of traffic from the incoming road to the outgoing road via the intersection node; and
generate, based on an angular relationship between the outgoing road and the incoming road, in the one or more data records, type data indicative of a type of the restriction.

2. The processing apparatus as claimed in claim 1,
wherein, for generating the result data, the processing apparatus is configured to generate the result data indicative of the result that is determined based on a ratio defined by the second count to the first count, and
wherein the result satisfies the condition for restriction if the result is less than a defined threshold.

3. The processing apparatus as claimed in claim 2,
wherein, for generating the restriction data, the processing apparatus is configured to generate the restriction data if the result satisfies the condition for restriction, and if the second count is less than another defined threshold.

4. The processing apparatus as claimed in claim 1, wherein, starting from the incoming road to the outgoing road in an anti-clockwise direction,
if the angular relationship between the outgoing road and the incoming road comprises an angle in a first range of between about 80□ and about 100□, the processing apparatus is configured to, for generating the type data, generate the type data indicative of a no-right turn restriction; and
if the angular relationship between the outgoing road and the incoming road comprises an angle in a second range of between about 255□ and about 285□, the processing apparatus is configured to, for generating the type data, generate the type data indicative of a no-left turn restriction.

5. The processing apparatus as claimed in claim 4, wherein, starting from the incoming road to the outgoing road in an anti-clockwise direction, if the angular relationship between the outgoing road and the incoming road comprises an angle outside of the first range and the second range, the processing apparatus is configured to, for generating the type data, generate the type data indicative of a no-entry restriction.

6. The processing apparatus as claimed in claim 1, further configured to generate, if a degree of an end node associated with the outgoing road is determined to be one, in the one or more data records, data indicative of the outgoing road being a dead-end road.

7. The processing apparatus as claimed in claim 1, further configured to add the restriction data and the type data to data corresponding to the network of roads.

8. The processing apparatus as claimed in claim 1, further configured to, in response to a request from a user to access data associated with the intersection node, communicate the restriction data and the type data to a device of the user for communicating the restriction and the type of the restriction to the user.

9. The processing apparatus as claimed in claim 1, further configured to process data indicative of a digital map representative of the network of roads, the restriction data and the type data for communicating information corresponding to the restriction and the type of the restriction with the digital map.

10. A method for traffic management of a network of roads, the method comprising:
generating, based on journey data sets, each journey data set comprising data indicative of a journey by a road user that comprises traversing an intersection node of the network of roads and being derived using geolocation transmissions from a communications device of the road user, in one or more data records,
first count data indicative of a first count of the road users travelling on an incoming road leading to the intersection node, and
second count data indicative of a second count of the road users travelling on an outgoing road of at least two outgoing roads, each outgoing road leading away from the intersection node,
wherein the incoming road and the at least two outgoing roads intersect at the intersection node;
generating, in the one or more data records, result data indicative of a result that is determined based on the first count and the second count;
if the result satisfies a condition for restriction, generating, in the one or more data records, restriction data indicative of a restriction of traffic from the incoming road to the outgoing road via the intersection node; and
generating, based on an angular relationship between the outgoing road and the incoming road, in the one or more data records, type data indicative of a type of the restriction.

11. The method as claimed in claim 10,
wherein generating the result data comprises generating the result data indicative of the result that is determined based on a ratio defined by the second count to the first count, and
wherein the result satisfies the condition for restriction if the result is less than a defined threshold.

12. The method as claimed in claim 11,
wherein generating the restriction data comprises generating the restriction data if the result satisfies the condition for restriction, and if the second count is less than another defined threshold.

13. The method as claimed in claim 10, wherein, starting from the incoming road to the outgoing road in an anti-clockwise direction,
if the angular relationship between the outgoing road and the incoming road comprises an angle in a first range of between about 80⁰ and about 100⁰, generating the type data comprises generating the type data indicative of a no-right turn restriction; and
if the angular relationship between the outgoing road and the incoming road comprises an angle in a second range of between about 255⁰ and about 285⁰, generating the type data comprises generating the type data indicative of a no-left turn restriction.

14. The method as claimed in claim 13, wherein, starting from the incoming road to the outgoing road in an anti-clockwise direction, if the angular relationship between the outgoing road and the incoming road comprises an angle outside of the first range and the second range, generating the type data comprises generating the type data indicative of a no-entry restriction.

15. The method as claimed in claim 10, further comprising generating, if a degree of an end node associated with the outgoing road is determined to be one, in the one or more data records, data indicative of the outgoing road being a dead-end road.

16. The method as claimed in claim 10, further comprising adding the restriction data and the type data to data corresponding to the network of roads.

17. The method as claimed in claim 10, further comprising, in response to a request from a user to access data associated with the intersection node, communicating the restriction data and the type data to a device of the user for communicating the restriction and the type of the restriction to the user.

18. The method as claimed in claim 10, further comprising processing data indicative of a digital map representative of the network of roads, the restriction data and the type data for communicating information corresponding to the restriction and the type of the restriction with the digital map.

19. (canceled)

20. A non-transitory storage medium storing instructions, which when executed by a processor cause the processor to perform a method for traffic management of a network of roads, he method comprising:
generating, based on journey data sets, each journey data set comprising data indicative of a journey by a road user that comprises traversing an intersection node of the network of roads and being derived using geolocation transmissions from a communications device of the road user, in one or more data records,
first count data indicative of a first count of the road users travelling on an incoming road leading to the intersection node, and
second count data indicative of a second count of the road users travelling on an outgoing road of at least two outgoing roads, each outgoing road leading away from the intersection node,
wherein the incoming road and the at least two outgoing roads intersect at the intersection node;
generating, in the one or more data records, result data indicative of a result that is determined based on the first count and the second count
if the result satisfies a condition for restriction, generating, in the one or more data records, restriction data indicative of a restriction of traffic from the incoming road to the outgoing road via the intersection node; and
generating, based on an angular relationship between the outgoing road and the incoming road, in the one or more data records, type data indicative of a type of the restriction.
